(19) United States
(12) Patent Application Publication
(10) Pub. No.: US 2002/0184312 A1
(43) Pub. Date: Dec. 5, 2002

(54) Computer networks simultaneously sharing images and data with individual scan and reset by a plurality of users - systems, methods & program products

(75) Inventors: Shu-Chun Jeane Chen, San Diego, CA (US); Ephraim Feig, San Diego, CA (US)

Correspondence Address: Morgan & Finnegan, L.L.P., 345 Park Avenue, New York, NY, 10154-0053, US

(73) Assignee: International Business Machines Corproration, Armonk, NY (US)

(21) Appl. No.: 09/867,528

(22) Filed: May 31, 2001

(51) Int. Cl. G06F 15/16

(52) U.S. Cl. 709/205; 707/104.1

(57) ABSTRACT

A computer network including a server for receiving and sharing a presentation of foils with a plurality of user clients under the control of a presenter. Each user client has a terminal for displaying the foils; a browser for interacting with the server and a cache for storing the foils. Each foil is contained in a data structure, typically a HyperText Markup Language (HTML) page including a time line of past foils which enables a user through an interface to view each foil, scan over the time line to view any past foil and quickly reset the presentation to the current foil viewed on the network by the other user clients. Each user or viewer in scanning or browsing through the past foils does not interfere with other user clients viewing the presentation or to the presenter.

### BACKGROUND OF THE INVENTION

1. Field of Invention

This invention relates to computer networks simultaneously sharing images and data with a plurality of users. More particularly, the invention relates to computer networks simultaneously sharing images and data with individual scan and reset by a plurality of users.

2. Description of Prior Art

Application sharing in computer networks is finding greater appeal among network users. A typical application may be a presentation comprising various pages or foils accompanied by voice and sound. The succession of pages or foils is viewed simultaneously by the several users, each on his own computer monitor. A presenter at a host computer decides the foils and the pace of the foils to be viewed at any given time by the users. However, a user will be unable to jump back to a previous foil because the control of the foils is at the host computer by the presenter. In order to review a previous foil, the presenter must stop the presentation and back track to the desired foil; provide explanation of that foil, if necessary; and then, return to the foil from which the presentation departed. Such practice if adopted by a presenter may be detrimental to the presentation and, in any event, inconvenient to other users.

Thus, there is a need in computer networks to provide images and data simultaneously to a group of users, which enables each user to regulate the images and content as well as the pace of delivery on the respective computer monitors of a plurality of users.

Prior art related to computer networks delivering information simultaneously to a plurality of users includes the following:

U.S. Pat. No. 5,241,625 issued Aug. 31, 1993, discloses a system for remotely observing and optionally controlling information, including text and graphical images displayed on a computer from among both homogeneous and heterogeneous computers coupled in a network or via other transport media such as magnetic disks captures window system event messages during a recording process. Such messages are then translated into procedure calls during the imaging process on a destination platform.

U.S. Pat. No. 5,920,694 issued Jul. 6, 1999 discloses a system in which multiple computers engage in a collaborative video conference. One computer generates a common image, which is distributed to the other computers. The system allows the users of the other computers to annotate (that is, mark up, by drawing and text) the image at their respective computers. The annotations are replicated at the other computers.

U.S. Pat. No. 5,949,975 issued Sep. 7, 1999, discloses a Multipoint Application Sharing (MAS) system that resides at each computer in a network of computer systems. The MAS at each computer system communicates with each MAS at each other computer system by sending messages over the network. The MAS system enables a user at each computer system to share one or more application programs with each user at each other computer system. To share an application program, a user at a host computer invokes the application program. Then, the user requests the MAS system to share the invoked application program with users at other computers. Each computer that is sharing the application can view the output of the application and can take control of the application so that it can send remote keyboard and pointing device information to the application.

U.S. Pat. No. 5,781,727 issued Jul. 14, 1998 discloses a collaborative system for allowing users to draw annotation images on a user display and replicating the annotation images on the display of all other computers. An application program can run on a single computer, yet participants can issue commands to the program. Remote participants can watch the program operate because the application replicates the display window of the running program on tot he displays of the remote computers. Any participant can make annotations on the participant's own computer display. The application copies the annotation to the displays of the other participants.

U.S. Pat. No. 5,526,480 issued Jun. 11, 1996, discloses a data processing system for efficiently managing the selection and/or presentation of a multimedia data set comprised of multiple topics. A display is provided for presenting a multimedia data set. A graphic control mechanism having multiple portions is presented within the display. Each of the portions of the graphic control mechanism is associated with a selected one of the multiple topics and such an association is graphically displayed. A user is permitted to select one of the multiple portions of the graphic control mechanism. In response to a user's selection, one of the multiple portions and associated with a multiple topics is automatically presented.

U.S. Pat. No. 5,727,950 issued Mar. 17, 1998 discloses a system and method for interactive, adaptive, and individualized computer-assisted instruction. Computers interconnected by a network so that instruction can deliver instructions to geographically distributed students whereby the system acts as a virtual tutor adapted to the student. The virtual tutor guides the interactive instructions of the students and individualizes the instruction to the student.

None of the prior art discloses a computer network in which a host presenter simultaneously shares images and data in a presentation format with a plurality of users or viewers enabled to scan and reset the images in data to their particular need without interference to the progress of the presentation or to the presenter or other viewers.

### SUMMARY OF THE INVENTION

An object of the invention is a computer network, method of operation and program product for simultaneously sharing images and data in a presentation with individual scan and reset by a plurality of viewers/users.

Another object is a computer network, method of operation and program product for sharing a presentation with a plurality of user clients enabled to access the presentation at any point.

Another object is a computer network, method of operation and program product enabling viewers/users to review past images and data of a presentation without interference to the progress of the presentation or to other user clients.

Another object is a computer network, method of operation and program product enabling a user client to review any previous image or data during a presentation and to jump forward to the point in the presentation at which the user client departed.

These and other objects, features and advantages are achieved in a computer network including a server for receiving and sharing a presentation of foils with a plurality of user clients under the control of a presenter. Each user client has a terminal for displaying the foils; a browser for interacting with the server and a cache for storing the foils. Each foil is contained in a data structure, typically a HyperText Markup Language (HTML) page including a time line of past foils which enables a user through an interface to view each foil, scan over the time line to view any past foil and quickly reset the presentation to the current foil viewed on the network by the other user clients. Each user or viewer in scanning or browsing through the past foils does not interfere with other user clients viewing the presentation or to the presenter.

### BRIEF DESCRIPTION OF THE DRAWINGS

The invention will be further understood from the following detailed description of a preferred embodiment, taken in conjunction with an appended drawing, in which:

FIG. 1 is a computer network including a server for interactive application sharing with individual scans and resets between a leader and a plurality of user clients.

FIG. 2 is a representation of the server included in FIG. 1.

FIG. 2A is a more detailed description of the server shown in FIG. 1.

FIGS. 3A-3D are representations of successive web pages in a presentation distributed by the leader to an audience of a plurality of user clients over the computer network of FIG. 1.

FIG. 4 is a representation of a web browser used by the leader in conducting the presentation of FIGS. 3A-D.

FIG. 5 is a representation of a web browser of an audience user for receiving the presentation of FIGS. 3A-D.

FIG. 6 is a flow diagram at the server and FIG. 1 to setup a presentation for the leader.

FIG. 7 is a flow diagram at the server of FIG. 1 showing the interaction between the server and the leader user computer.

FIG. 8 is a flow diagram at the server of FIG. 1 showing the interaction with an audience user client computer.

FIG. 9 is a flow diagram of a coded URL browser request between the leader and an audience user client computer.

### DESCRIPTION OF THE PREFERRED EMBODIMENT

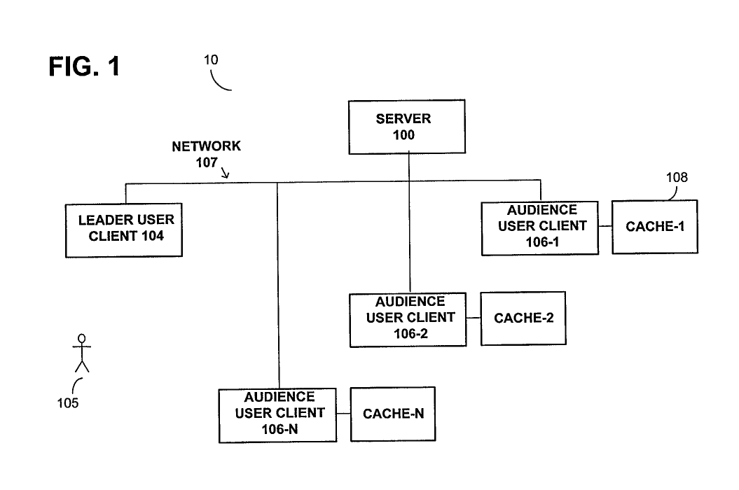

In FIG. 1, a computer network 10 illustrates the relationships among a server computer 100, a leader user client computer 104 and audience client computers 104, 106-1, 106-2 . . . 106-N as they are interconnected over a network 107. Each user client computer 106 includes a cache 108 for storing foils and other data related to a presentation prepared by a leader 105 at the leader user computer 104 or other media device and simultaneously distributed to the audience user client computers 106 via the server 100 under control of the leader 105. The network 107 can be any distributed information network e.g., the internet. The internet standards and protocol are described in the text “Internet Standards and Protocols” by D. C. Neik, Microsoft Press, Redmond Wash., 1998. An operating system in the server computer 100 can be for example, Microsoft Windows NT, Red Hat Linux, IBM AIX or other suitable server computer operating systems commercially available from e manufacturer. The operating system in a client computer 104, 106-1, 106-2, 106N can be for example, Microsoft Windows NT. Details of the Windows NT operating system are described in the text entitled “WIN 32 Systems Services” by N. Brain, published by Prentice Hall, Englewood Cliffs, N.J. 1996. A browser program (not shown) in client computers 104,106-1, 106-2, 106-N can be for example, Netscape Communicator or Microsoft Internet Explorer Browser program. A description of the Microsoft Internet Explorer Browser Program is provided in the text “Programming Microsoft Internet Explorer 5” by S. Robert, Microsoft Press, Redmond Wash., 1999.

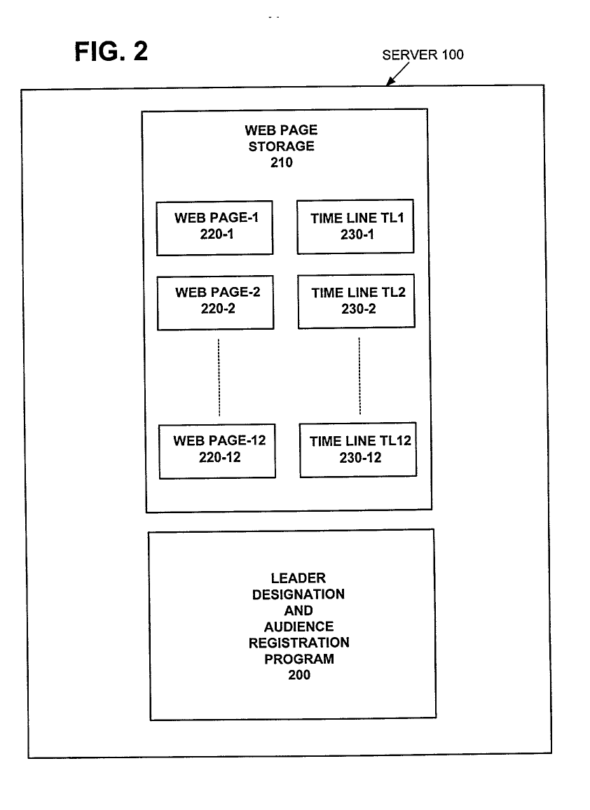

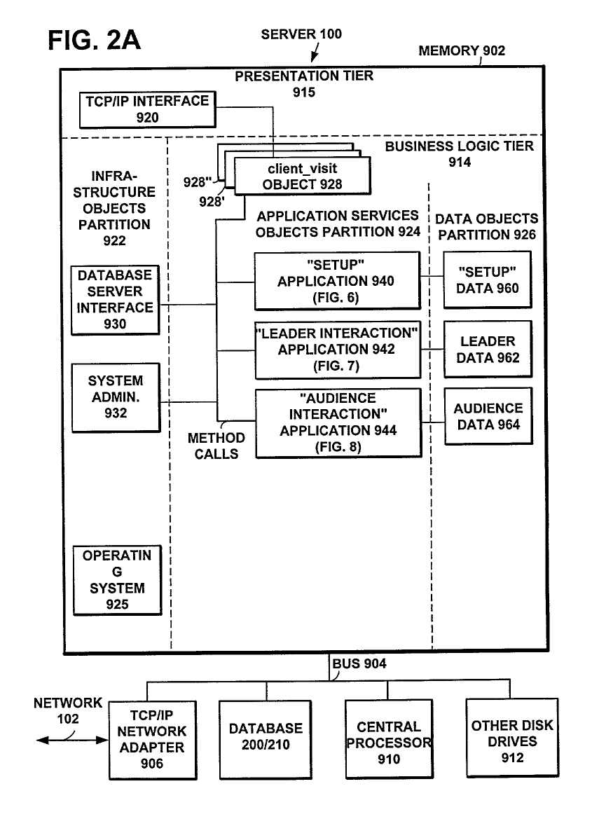

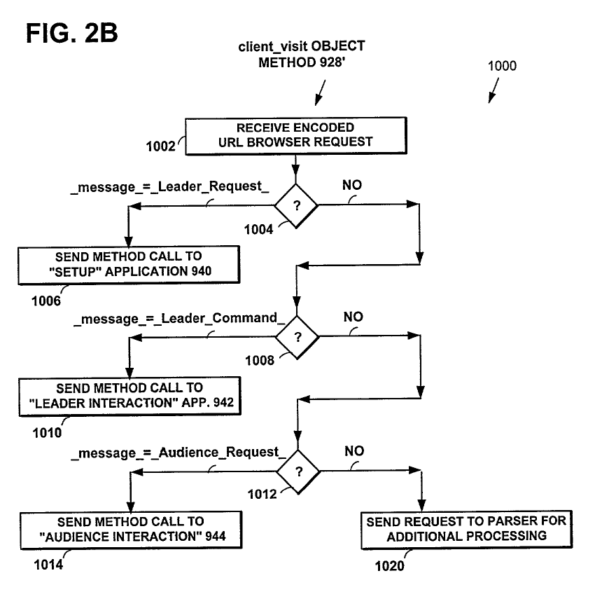

In FIG. 2, the server 100 is a standard HTTP server running an application sharing program. For example, an E-Commerce programming application developed with Enterprise Java-beans is described in the text “Mastering Enterprise Java Beans” by Ed Roman, John Wiley and Sons, 1999. A description of the use of an object model in a design of a web server computer for E-Commerce Applications is provided in the text “Beginning E-Commerce” by Matthew Reynolds, Wrox Press Incorporated, 2000. Java servlets in a development web site server computers is further described in the text “Webbed Development With Java Server Pages” by Duane K. Fields, Manning Publications Company, 2000. Alternatively, other application sharing program include Microsoft Net Meeting; Lotus, Same, Time. A special feature of a server program is the assignment of host or leader status to one of the participants in the application sharing using a leader designation and audience registration program 200 to be described hereinafter.

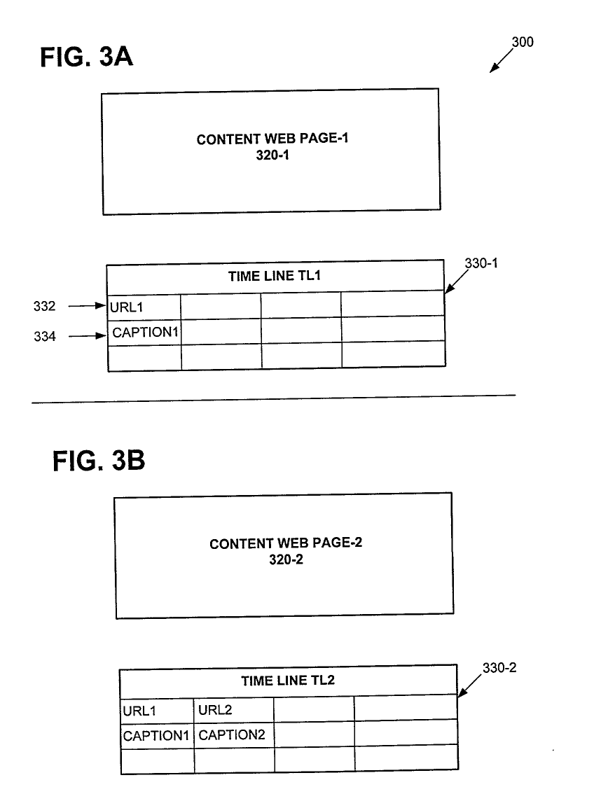

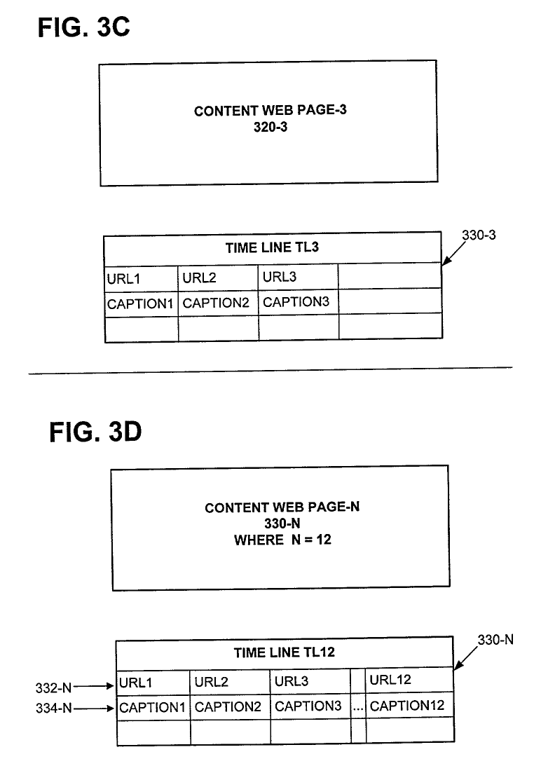

A leader 105 using the leader user client computer 104 (See FIG. 1) prepares a presentation for distribution to audience user/client computers 106-1, 106-N (See FIG. 1). The presentation is a series of foils stored in a web page storage 210 as a series of WebPages 220-1 . . . 220-N in standard HyperText Markup Language (HTML) forms. The principles of HTML document requests and response forms can be found in a number of text, for example, “Web Design In A Nutshell”, by J. Niederst, O'Reilly Press, 1999 or “Web Publishing with HTML 4” by L. LeMay, McMillan Press, 2000. Each web page is accompanied by a time line 230-1 . . . 230-N, which provides URL addresses to previous foils or web pages stored at he server 100. By scanning the time line an audience user client may access any past web page in the presentation, as will be described in connection with FIGS. 3A-D.

In FIG. 2A a functional block diagram of the server computer 100 implements the web page storage description of FIG. 2. A memory 902 stores components of software program objects needed to perform the operations of the server. The memory 902 is connected by a system bus 904 to a TCP/IP network adapter 906 for connecting the server 100 to the network 107 (See FIG. 1). A central processor 910 connected to the bus 904 executes the programs instructions stored in memory 902 using the database 200/210, described in FIG. 2. Additional or other disk drives 912 are connected by the bus 904 to the memory 902.

The central processor 910 can be for example and IBM RS6000 Enterprise Server computer or the IBM Web Sphere application server. (Web Sphere is a trademark of the IBM corporation). The Web Sphere application is an initial Java-based web application platform for managing Java-based E-Commerce application, accessing databases and handling internet transactions with remote clients and service. A description of the web sphere application server is provided in the text “IBM Web Sphere Starter Kit” by Ron Ben-Natan and Ori Sasson, McGraw Hill publishing 2000 (ISBN:0072124075). An additional description can be found on the internet web site:

www-4.IBM.com/software/developer/library/wsarchitecture/sarchitecture.html.

Java servlets and the developments of web site servers are described in the text “Web Development With Java Server Pages” by D. K. Fields et al. Manning Publishing Company 2000.

Continuing in FIG. 2A, various functional modules of the server computer 100 are arranged in an object model as shown. The object model groups the various object oriented software programs into components which perform the major functions and applications in the server computer 100. A description of object oriented programming is available in the text (Please provide a reference). Enterprise Java-Beans (EJB), previously described is a software component architecture for server computers, which is suitable for embodying the object oriented software program components of FIG. 2A. The components are organized in the memory 902 in a business logic tier 914, a presentation tier 915 and an infra-structure partition 922. The infrastructure objects partition 922 includes an object oriented software program component for a database server interface 930, an object oriented software program component for the system administrator interface 932, and an operating system 925. The operating system can be, for example IBM AIX, Microsoft Windows NT, Red Hat Linux, or the like.

The presentation tier 915 includes TCP/IP interface 920. The presentation tier 915 manages the graphical user interface with the visitor at the client computer 104 or 106. A suitable implementation for the presentation tier 915 can be done using Java servlets to interact with the visitor or client by means of a Hypertext Transfer Protocol (HTTP), described in the text “Internet Standards and Protocols” by D. C. Neik, Microsoft Press, Redmond, Wash., 1998. Java servlets run with a request/response server computer. Java servlets handle request messages from the visitor or client and return response messages to the visitor or client. The Java servlet is a Java object that takes a request as input, parses the data, performs some logic, and then issues a response back to the visitor or client. Java servlets are pooled and reused to service many visitor or client request. The TCP/IP Interface 920, implemented with Java servlets, functions as web server computer that communicates with the visitor or clients using HTTP protocol. The TCP/IP Interface 920 excepts each HTTP requests from the visitor and passes the information in the requests to a client visit object 928 in the business logic tier 914.

Result information returned from the business logic tier 914 is passed by the client visit object 928 to the TCP/IP Interface 920 which sends the results back to the visitor or client in an HTTP response. The TCP/IP Interface 920 exchanges data through the TCP/IP network adapter 906 to the network 107.

The business logic tier 914 is divided into two partitions: an application services objects partition 924 and a data objects partition 926. The business logic tier 914 includes multiple instances of user client visit objects 928, 928¹ and 928². Each visitor leader client computer 104 and client user 106 that send a message to the server computer 100 has a temporary and separate and client visit object 928 instantiated to represent the visit. The Enterprise Java-bean server computer 100 can instatiate multiple copies of client visit objects 928 in the business logic tier 914 to handle multiple messages from multiple visitors.

Each client visit object 928, 928¹ and 928² will buffer visitor-specific information and maintain a visitor-specific state for the duration of the session with the visitor. Each client visit object 928 is a stateful session bean that will hold the conversational state about the visitors visit. A stateful session bean is an Enterprise Java Bean that services business processes that span multiple method requests or transactions.

Each stateful session bean retains a state on behalf of an individual visitor. Data received by server computer 100 from Client computers 104 or 106, and data sent by the server computer 100 to the visitor will be temporarily buffered in a client visit object 928. Each client visit object 928 receives from TCP/IP interface 920, the visitor data sent by Client computer 104 or 106 to the server computer 100. Each client visit object 928 will also buffer the resulting information, which is computed by the server computer 100. The information is passed back to the TCP/IP interface 920.

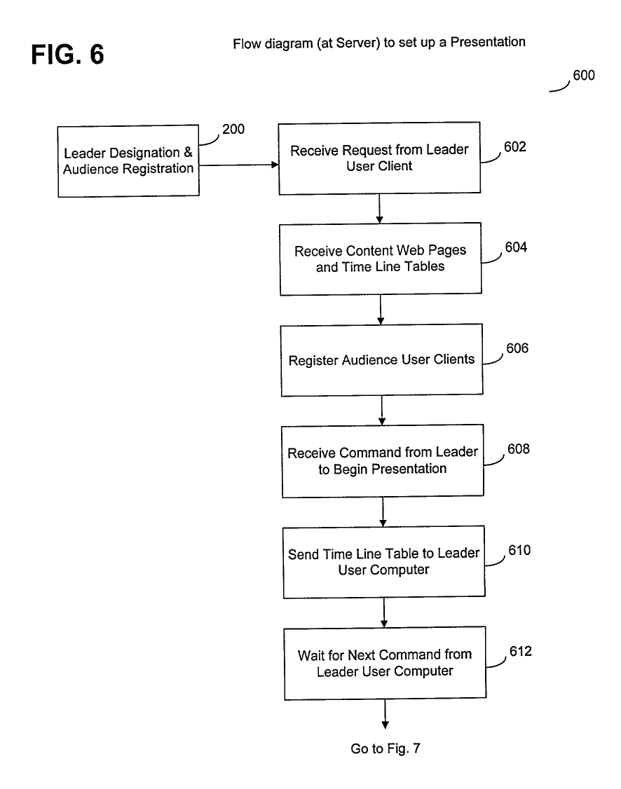

FIG. 2B, taken in conjunction with FIG. 2A, describes a process 1000 for responding to client browser request. When a message 1002 from a client computer 104 or 106 arrives and is received by the TCP/IP interface 920, a client visit object 928 is instantiated and the received data is passed to client visit object 928. Depending on the state of the transaction, a test 1004 is performed to determine whether the message is a “Leader Request” or not. For a “yes” condition, the client visit object will send the method call to one of the object oriented software components in the application services partition 924 of the server computer, otherwise for a “no” condition, the request is forward to the next test condition 1008. If the transaction at step 1004 is a “Leader Request” message, the client visit object will send a method call to setup application 940, which will perform the steps of a setup application method 940′ to be described in FIG. 6. The setup application will then setup a presentation via a setup data object 960. The client visit object 928 will then pass the result data back to the TCP/IP interface 920, which will send the result data back to the client computer 104 and 106.

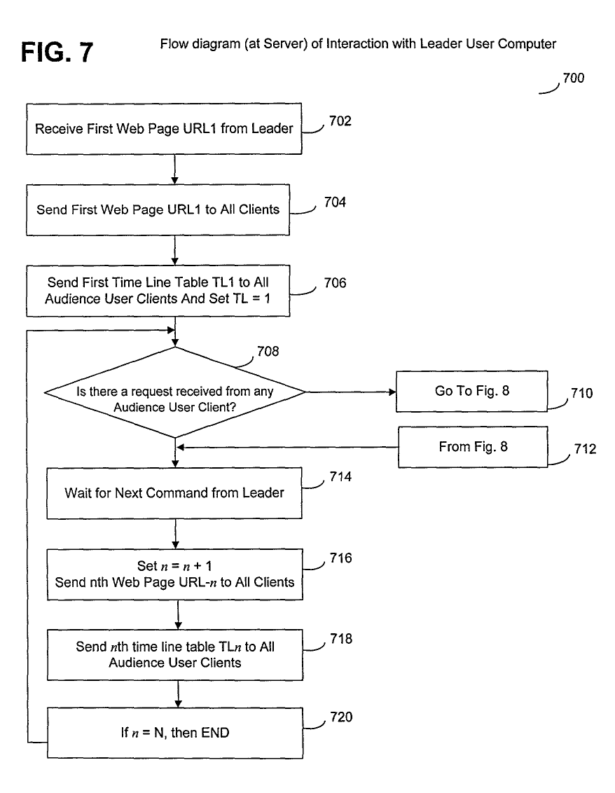

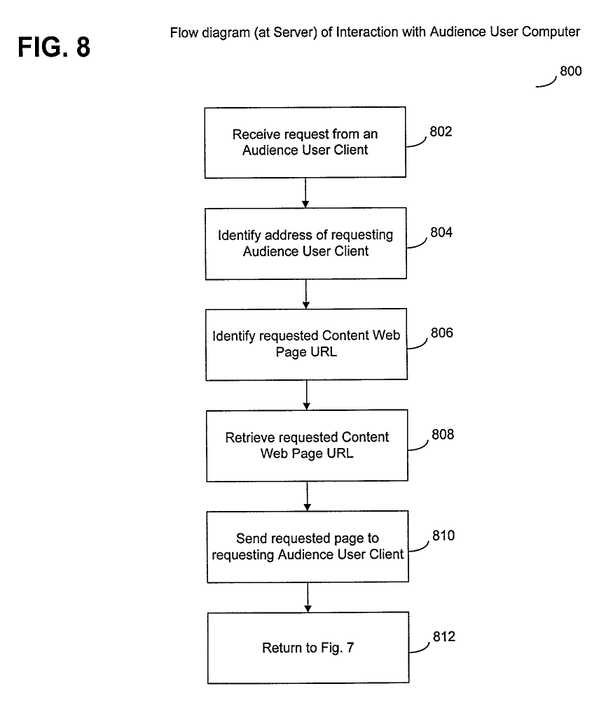

If the transaction is passed to the test condition 1008, a test is performed to determine if a “Leader Command” message has been received. For a “yes” condition, the client visit object 928 will then send a method call to implement the “Leader Interaction” application 942, to be described in conjunction with FIG. 7. The Leader Interaction application 942 will access data via a URL data object 962. The client visit object 928 will then pass the result data to the TCP/IP interface 920, which will send the data back to client computer 104 or 106.

If the transaction is passed to the test condition 1012, a test is conducted to determine the presence of an audience request message. For a “yes” condition, the client visit object 928 when then send a method call to the Audience Interaction application 944 which will perform the steps of the audience interaction application which will cause the server to send the correct HTML page to the requesting audience client computer. The application will be described in FIG. 8. If the test 1012 results in a “no” condition is a “no” condition an operation 1020 is sends a request to the parser in the presentation tier for additional processing.

Enterprise Java Beans support transaction processing, where a series of small operations are executed as one large atomic operation. An atomic operation allows multiple instantiations of client visit objects 928, representing multiple visitors, to invoke the same resource component, such as the “SETUP” application 940. When multiple calls are made on a method of the same resource component, the invocations are serialized and performed in lock-step. Any access to the database 200 or 210 will be handled through the database server interface 930.

FIG. 3A-D show successive web pages comprising a presentation 300 created by the leader 105 on the leader user client computer 104 o other r media device for storage on the server 100 and distribution to the audience user clients by the server interacting with and under the control the leader 105.

FIG. 3A is an HTML page comprising a content web page 320 containing presentation images or data to be viewed simultaneously by all audience clients at their respective computer monitors. A time line 330 is incorporated into the web page. The time line includes a series of cells 332 in juxtaposed rows, 332, 334, etc. The row 332 contains a cell for a Uniform Resource Locator (URL) for the first web page in the presentation displayed at all of the audience user client computers. The row 334 contains cell providing a caption or title of the presentation page associated with the URL. The caption enables an audience client user to select a web page for revisiting. By scanning or clicking on the URL with a cursor control unit, a user client hyperlinks to the server for display of the first page even though the server may be transmitting the next presentation page to the audience user client computers 106. The next page in the presentation, when received, is stored in the cache 108 until the user client terminates the first page whereupon the latest presentation page stored in the cache is called out by the user client and displayed at the associated with the user client computer 106.

FIG. 3B shows a second content web page 320-2 in the presentation 300. A time line 330-2 includes URL addresses for both the content page 330-1 and the content page 330-2. The cells 334 include the captions for the URL 1 and 2, respectively. A client user may at any time revisit content web page 320-1 or 320-2 by scanning or clicking on the desired URL FIG. 3C, shows content web page 320-3 in the presentation 300, and includes the time line 330-3. The cell 332 include the URL hyperlinks for the two previous and the current content pages 320-1, 320-2 and 320-3. Likewise, the cells 334 include the caption for all the respective content.web pages. It can be seen that a client user may hyperlink to any of the previous content web pages, but has no access to succeeding web pages in the presentation because the URL hyperlinks are not installed in their succeeding cells.

FIG. 3D describes a content web page 320-N where N is 12 which for purposes of explanation is the last web page in the presentation 300. The time line 230-12 provides the URL hyperlink and the cells 232 or the previous and current web pages. Likewise the cell 234 provides the caption for each of the associated URL hyperlinks. A user client has the options of selecting any prior web pages by scanning or clicking prior URL's shown in the timeline corresponding to the currently display web page. The selection may be done with out interference to the presentation or the leader or other audience user clients. The user client cannot view future web pages because URL's for future web pages are not available until the web content page is displayed all user client computers.

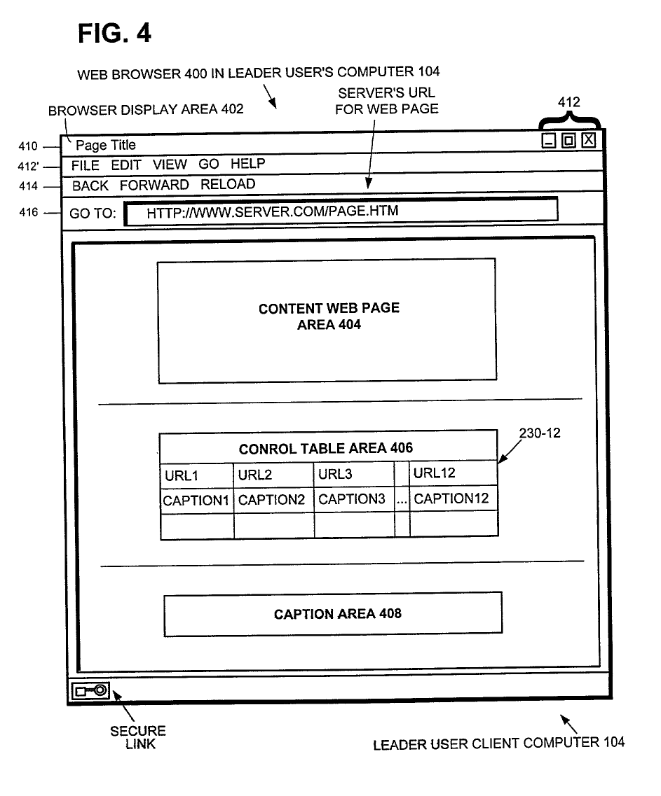

FIG. 4 shows a web browser screen 400 for a leader user computer 104. The browser can be a Microsoft Internet Explorer or Netscape Communicator Program, both available on the commercial market. The browser screen 400 provides a browser display area 402 within which is designated a content web page area 404 for the display of the content web pages, such as content web page 320-1. The display area has a control table area 406 which displays the time line including the sequence of past web pages by URL and caption in the presentation 300. A caption area 408 display the caption for the current web page displayed in the presentation . The browser screen may also include other standard informational and control bars provided by browsers. A page title bar 410 includes the page title and standard screen control functions minimize, maximize and cancel. An operational bar 414 includes standard operational buttons 414 file, edit, view, go, and help functions. Screen control bars 416 includes standard back, forward and reload instructions for the screen. A server address bar 418 provides a web address for the web page currently displayed.

In operation, the leader stores a file of the presentation at the server 100. To transmit a foil, the leader opens the file on the server and using a pointing device or mouse clicks on the foil in the file which the server transmits to all the audience user client computers and to the leader user client computers. Thereafter the server automatically send the foils to the leader user client and audience user clients as will be described in FIG. 7. The selected foil page appears in the content web page area 404 and the URL and caption for the file are entered into cells in the control table area 406 and the caption area 408. The address for the page appears in the web address bar 418. The leader may conduct a voice discussion about the foil with the audience user client over a voice conference circuit.

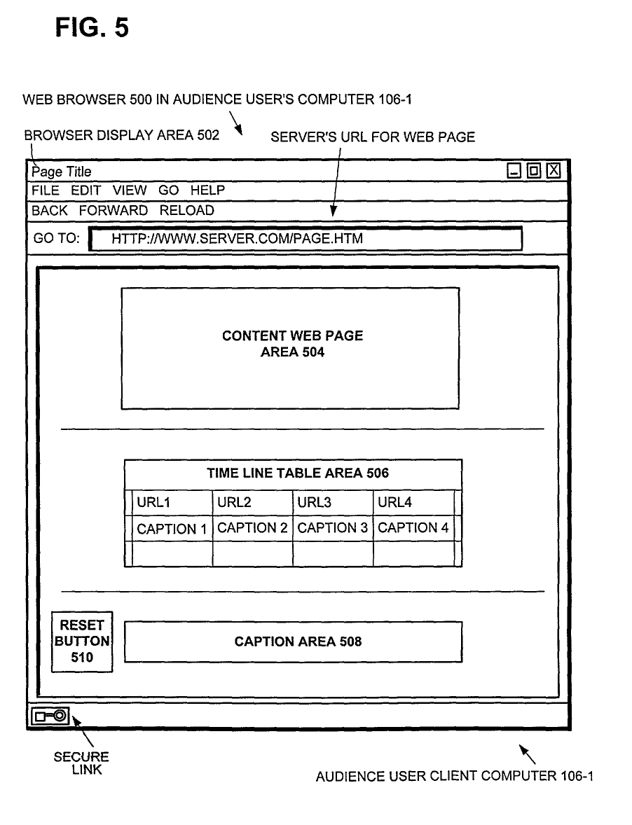

FIG. 5 shows an audience user client computer which includes a conventional web browser 500 having a browser display area 502 for an audience user computer, e.g. 106-1. The display area is the same as the leader user client browser 402, previously described except for redesigning the control table area as a time line area 506 and including a reset button 510. The time line area for 506 serves to display the time line table corresponding to the current content web page while including past web content page. For example, if the content web page 2 designated as 202-2 is displayed in the content web page display 504, the corresponding time line table TL2, designated 230-2 would be displayed in the time line area 506. Again, as the mouse connected to the audience user client computer rolls over the respective cells of the time lane table, corresponding text option is displayed in the caption area 508. If the audience user client desires to select a previous foil, the reset button is operated while the mouse is suppressed when the cursor is located on a particular cell or time line table. The URL for the selected cell is transmitted from the audience user client to the server. The URL commands the server to respond with the corresponding web page selected by the requesting audience user client. However, the audience user client can not select succeeding foils because their URLs and captions have not been entered into the time line table and caption areas.

It will be recalled from FIG. 1, each respective audience user client computer has a cache memory which is used during an interval when an audience client computer is reviewing earlier content web pages. During such interval period when the server transmits a new current content web page. That new web page will be stored in the cache memory. Thereafter, when the user client cancels the screen, the current work page stored in the cache memory will be accessed and displayed in the content web page area 504. The corresponding time line table area 506 will display the current time line table for the retrieved foil.

As another example, at a moment in the presentation session when the leader is discussing content web page 5, the audience user client selects from the time line table, the second web page having a URL 2. The audience user client operates the reset button 510 and the audience user client computer transmits the URL 2 for the server 100. The server 100 responds to the audience user client with web page 2 which is displayed on the content web page 504 overriding the current web page 5. After the user is satisfied with the review of the web page 2, the screen is cancelled and the latest foil is retrieved from the cache for display along with corresponding entries into the time line table area and caption areas.

FIG. 6 shows a process 600 for implementing a Set Up application 940 (See FIG. 2A.after a leader designation and audience registration program 200 has been completed. The program 200 is a standard application program presently available such as Microsoft Net Meeting, Lotus's Same Time which assigns host or leader status to one of the participants in the application sharing process. After selection of the leader and registration of the audience client user computers done through the application 200, the SetUp application 940 is implemented in the server 100 as previously described in FIGS. 2A and 2B. As a part of the implementation process, the server in step 602 receives a request from the leader user client to establish a session presentation which links the leader to all of the audience user client computer registered to receive the presentation. In step 604, the leader transmits to the server the content web pages and corresponding time lines, such as are shown in FIGS. 3A-3D which are stored in a file available to the leader 105 (See FIG. 1). In step 606, the server registers the audience user client by their respective URL addresses in the network 107. At the end of step 606, the basic setup of preparation of the presentation session is completed. At a later time, in step 608, the server receives a command from the leader user client to begin the presentation. In step 610, for each leader request, the server sends to the leader and the audience user clients the selected foil together with the time line table and caption area information for the corresponding foil. With the foil displayed at the leader user client and audience user client computers, the leader may conduct a tutorial of the foil using a conference voice circuit to supplement the foil and communicate with the audience user clients and optionally using a pointer in the screen to indicate points of interest in the tutorial. . During the tutorial, the server, in step 612, waits for the next command from the leader user computer to continue the presentation with the selection of the next foil by the leader.

FIG. 7 describes a process 700 which implements the server and leader user client computer interaction of the Leader Interaction Application 942 described in FIGS. 2A and 2B. In step 702, the server receives the selection of a first web page URL 1 from the user leader computer. In step 704, the server sends the first web page URL to all of the client users 106-1 . . . N. The web page will be presented to the leader user computer browser in the content web page area 404. The same web page will be presented to the audience user browser in the content web page 504. In step 706, the server send the first time line TL1 to all audience user client, and also sets a parameter “N” equals 1. The time line table will be broadcast to all of the audience users, such as 106-1 . . . 106-N. The time line table will be presented on the browser 500, in the time line table area 506 for each audience user client. In step 703, the process 700 determines if there is a request received from any audience user client computer. If an audience user client request is indicated, the process transfers to FIG. 8 which will be described hereinafter. Otherwise, if there is no request received, the flow of the process proceeds to step 714 which waits for the next command from the leader user computer.

Continuing in FIG. 7, the process 700 proceeds to step 716 where the parameter N is sent equal to N+1. The server sends the N web page URL-n to all clients. For example, if N had the value of 3 then step 716 would increment the value of N to 4 and then the 4^{th} web page URL 4 would be sent to all clients. All the clients, including the leader user client 104 and all of the audience user client computers 106 through 106-1. N received the 4^{th} content web page which would be displayed in the corresponding content web page of the respective browsers. In Step 718, the process sends the time line table TLn to all audience user clients. In this example, if the incremented value of N is now 4, then the 4^{th} time line TL4 is sent to all audience users clients 106-1.N. The time line table TL4 in this example will be displayed in the corresponding time line area 506 of each respective audience user client computer. In step 720 the process determines if n if equal to N, which is a maximum number of content web pages. If n equals N the program ends. If not the program moves back to step 708.

In the event that a request is received from an audience user client for previous foil, a process 800 shown in FIG. 8 implements the Audience Interaction Application 944 previously described in FIGS. 2A and 2B. In step 802, the server receives a request from the audience user client. As an example, the audience user 1 and the client computer 106-1 transmits a request for the second web URL2 as was discussed in the example above. The audience user client computer 106-1 initiates requests by a user causing the cursor to roll over the second cell containing UR2 in the time line table area 506. The caption 2 will displayed in the captioned area 508 which indicates through the user that this is in fact a desired earlier web that is the access server 100. The user depresses the mouse button and the reset button 510. A GET request for URL2 is set from the audience user client computer to the server 100.

In step 804, the server identifies the URL address of the requesting audience user computer as user computer 106-1. In step 806, the server identifies the requested content web page URL which in this case is URL2, which was received by the server in the GET request from the audience user client computer 106-1. In step 808, the server retrieves the requested content web page URL2 from the web page storage area 210 (See FIG. 2). In step 810, the server sends the requested page to the audience user client computer 106-1. In step 812, the process returns to the flow diagram of FIG. 7 making an entry at the beginning of step 714.

The requested web page, for example the content web page 2 is received at the requesting audience using computer 106-1 and overwrites the currently displayed web page in the content web page area 504. The user can review any preceding web pages by selecting the corresponding URL in the time line table area 506. During the interval the user is reviewing the previous web page, the server continues to broadcast new web content pages. The new web content page will be received by the audience user client computer 106-1, and because the client computer is in a reset mode, the new web page will be stored in the cache memory as previously described. Thereafter, when the user cancels the web page, the current content of the cache which is a latest web page 6 will be accessed from the cache and displayed in the content page 504. Thus, the leader user computer has complete control over the order and sequence of presentations during the session. Yet, a member of the audience can select earlier web pages to review. However, the audience user client computer is prevented from accessing web pages future display because the audience user client computer does not have a time line table containing the URL directed to such future web pages.

While the invention has been shown and described in conjunction with a preferred embodiment, various changes may be made without departing from the spirit and scope of the invention as defined in the appended, in which:

We claim:

1. A computer network for simultaneously sharing images and data in a presentation with individual scan and reset by a plurality of viewers/users, comprising:
a) a server coupled via the network to a plurality of computers for purposes of conducting the presentation;
b) a selecting apparatus coupled to the network and selecting one of the computers as a leader user client computer, the remaining computers serving as audience user client computers;
c) a transmitting apparatus coupled to the server and transmitting the presentation as a series of web pages from the server to the leader user client and audience user client computers; and
d) a displaying apparatus at the leader user client and audience user client computers which displays each web page including a time line table identifying each web page displayed in the presentation.

2. The computer network of claim 1 further comprising:
e) a web page identification apparatus which identifies the location of each web page in the presentation by a Uniform Resource Locator in the time line table.

3. The computer network of claim 2 wherein the web page identification apparatus further identifies each web page in the presentation by a caption in the time line table.

4. The computer network of claim 1 further comprising:
f) a storage apparatus which stores web pages transmitted by the server to the audience user client computers.

5. The computer network of claim 1 further comprising:
g) a reset apparatus in each audience user client computer enabling a viewer/user to select a different web page than the current web page displayed at the audience user client computers.

6. The computer network of claim 1 further comprising:
h) an entering apparatus in the leader user client and audience user client computer which enters successive URL's and corresponding web page captions in the time line table as the presentation progresses.

7. The computer network of claim 1 further comprising:
i) browser software stored in the leader user client and audience client computers for interacting with the server.

8. The computer network of claim 1 wherein the web page is in the HTML format.

9. The computer network of claim 1 wherein the network is the Internet.

10. The computer network of claim 1 wherein the server uses HTTP protocol.

11. A server for simultaneously sharing images and data in a presentation with individual scan and reset by a plurality of viewers/users, comprising:
a) a memory coupled to a processor, a network adapter and a database via a data base;
b) a presentation tier installed in the memory which interfaces with leader user client and audience user client computers via a network in receiving and responding to requests from the leader user client and audience user client computers;
c) a business logic installed in the memory which processes and responds to the requests received by the presentation tier;
d) visitor object software installed in the business logic tier which tracks each request received by presentation tier; and
e) a database server interface which provides web pages in a presentation to the leader user client and audience user client computers in response to requests from the leader user client computer.

12. The server of claim 11 further comprising:
f) an application services objects partition including software setting up the sharing of images and data by the leader user client and audience user client computers.

13. The server of claim 11 further comprising:
g) leader interaction application installed in an application services object partition, the software implementing requests from the leader user client computer to the server and responding to the leader user client requests by the server.

14. The server of claim 11 further comprising:
h) audience interactive application software installed in an application services object partition, the software implementing requests from the audience user client to the server and responding to the audience user client computers by the server.

15. The server of claim 11 further comprising:
i) visitor object software which processes requests from the leader user client and audience user client computers and determines whether the requests is a setup application or leader interaction or audience interaction request and directing the request to the determined application for processing and response to the requesting leader user client computer or to the audience user client computer.

16 A method for simultaneously sharing images and data in a presentation with individual scan and reset by a plurality of viewers/users, comprising the steps of:
a) coupling a server via a network to a plurality of computers for purposes of conducting the presentation;
b) selecting one of the computers as a leader user client computer, the remaining computers serving as audience user client computers;
c) transmitting the presentation as a series of web pages from the server to the leader user client and audience user client computers; and
d) displaying at the leader user client and audience user client computers each web page including a time line table identifying each web page displayed in the presentation.

17. The method of claim 16 further comprising the step of:
e) identifying the location of each web page in the presentation by a Uniform Resource Locator in the time line table.

18. The method of claim 16 further comprising the step of:
f) identifying each web page in the presentation by a caption in the time line table.

19. The method of claim 16 further comprising the step of:
g) storing web pages transmitted by the server in a cache associated with each audience user client computers.

20. The method of claim 16 further comprising the step of:
g) enabling a viewer/user to select a different web page than the current web page displayed at the audience user client computers.

21 The method of claim 16 further comprising the step of:
h) entering successive URL's and corresponding web page captions in the time line table of each web page as the presentation progresses.

22. The method of claim 16 further comprising the step of:
i) storing browser software in the leader user client and audience client computers for interacting with the server and forming a web content page area, a time line table area and a caption area in a screen.

23. A program medium, executable in a computer system, for simultaneously sharing images and data in a presentation with individual scan and reset by a plurality of viewers/users, comprising:
a) program instruction in the medium coupling a server via a network to a plurality of computers for purposes of conducting the presentation;
b) program instruction in the medium selecting one of the computers as a leader user client computer, the remaining computers serving as audience user client computers;
c) program instruction in the medium transmitting the presentation as a series of web pages from the server to the leader user client and audience user client computers; and
d) program instruction in the medium displaying at the leader user client and audience user client computers each web page including a time line table identifying each web page displayed in the presentation.

24. The program medium of claim 23 further comprising:
e) program instruction in the medium identifying the location of each web page in the presentation by a Uniform Resource Locator in the time line table.

25. The program medium of claim 23 further comprising:
f) program instruction in the medium identifying each web page in the presentation by a caption in the time line table.

26. The program medium of claim 23 further comprising:
g) program instruction in the medium storing web pages transmitted by the server in a cache associated with each audience user client computers.

27. The program medium of claim 23 further comprising:
g) program instruction in the medium enabling a viewer/user to select a different web page than the current web page displayed at the audience user client computers.

28. The program medium of claim 23 further comprising:
h) program instruction in the medium entering successive URL's and corresponding web page captions in the time line table of each web page as the presentation progresses.

29. The program medium of claim 23 further comprising:
i) program instruction in the medium storing browser software in the leader user client and audience client computers for interacting with the server and forming a web content page area, a time line table area and a caption area in a screen.

30. In a server, a method for simultaneously sharing images and data in a presentation with individual scan and reset by a plurality of viewers/users, comprising the steps of
a) coupling a memory coupled to a processor, a network adapter and a database via a data base;
b) installing a presentation tier for interfacing with leader user client and audience user client computers via a network in receiving and responding to requests from the leader user client and audience user client computers;
c) installing a business logic in the memory for processing and responding to the requests received by the presentation tier;
d) installing a visitor object software in the business logic tier for tracking the each request received by presentation tier; and
e) providing a database server interface for web pages in a presentation to the leader user client and audience user client computers in response to requests from the leader user client computer.

31. The method of claim 30 further comprising the step
f) setting up the sharing of images and data by the leader user client and audience user client computers using a set up application.

32. The method of claim 30 further comprising the step of:
g) installing a leader interaction application implementing requests from the leader user client computer to the server and responses to the leader user client requests by the server.

33. The method of claim 30 further comprising the step of:
h) installing an audience interactive application handling requests from the audience user client to the server and responses to the audience user client computers by the server.

34. The method of claim 30 further comprising the step of:
i) processing requests from the leader user client and audience user client computers and determining whether the requests is a setup application or leader interaction or audience interaction request and directing the request to the determined application for processing and response to the requesting leader user client computer or to the audience user client computer.
